(19) United States
(12) Patent Application Publication
(10) Pub. No.: US 2022/0375369 A1
(43) Pub. Date: Nov. 24, 2022

(54) Wire Fence Marker

(71) Applicant: J.M.A.C. Properties of Arkansas, LLC, Cabot, AR (US)

(72) Inventor: John Gaunt, Cabot, AR (US)

(21) Appl. No.: 17/323,794

(22) Filed: May 18, 2021

(51) Int. Cl. G09F 7/18

(52) U.S. Cl. CPC G09F 7/18; G09F 2007/1839

(57) ABSTRACT

A wire fence marker which attaches to a fence wire or cable via one or more slots and which is secured to the fence via fasteners attached to the marker body.

### BACKGROUND OF THE INVENTION

The present invention is in the technical field of fences and barriers. More particularly, the present invention is in the technical field of marking devices for wire strand fences and cable strand barriers.

Conventional wire strand fences and cable strand barriers are very common due to their ease of erection, cost effectiveness, and effectiveness as a barrier to people, animals, and vehicles. However, conventional wire strand fences and cable strand barriers do not allow fora simple and secure method of affixing signage or other markers to them. The present invention is a device which can be quickly and securely affixed to a wire strand fence or cable strand barrier which can serve as a sign, marker, or means of attaching a separate sign or other attachment. When attached, the present invention clearly marks the fence or barrier to which it is affixed to aid in visibility, identifying property lines, or affixing signage.

### SUMMARY OF THE INVENTION

The present invention is a device designed to be easily and securely attached to the wires of a wire strand fence or cables of a cable strand barrier.

The advantages of the present invention include, without limitation, that it is simple to manufacture, simple in installation and operation and it is substantially more secure in its attachment to fence wire or cable than conventional methods. The use of specially designed slots in the device allows for easy, fast, and secure attachment to one or more fence wires or cable strands.

### BRIEF DESCRIPTION OF THE DRAWINGS

These and other features, aspects, and advantages of the present invention will become better understood with regard to the following description, claims, and accompanying drawings where:

FIG. 1 is a left side view of a wire fence marker of the present invention;

FIG. 2 is a right side view of a wire fence marker of the present invention;

FIG. 3 is a back side view of a wire fence marker of the present invention;

FIG. 4 is a back side view of a of a wire fence marker of the present invention which has been placed onto fence wires;

FIG. 5 is a left side view of a wire fence marker of the present invention;

FIG. 6 is a left side view of a wire fence marker of the present invention;

FIG. 7 is a left side view of a variation of the retaining slot of the present invention;

FIG. 8 is a left side view of a variation of the retaining slot of the present invention;

FIG. 9 is a left side view of a variation of the retaining slot of the present invention;

FIG. 10 is a left side view of a variation of the retaining slot of the present invention;

FIG. 11 is a left side view of a second embodiment of a wire fence marker of the present invention;

FIG. 12 is an isometric back side view of a second embodiment of a wire fence marker of the present invention which has been placed onto fence wires;

FIG. 13 is a back side view of a wire fence marker of the present invention;

FIG. 14 is a top view of a wire fence marker of the present invention; and

FIG. 15 is a front side view of a wire fence marker of the present invention.

### DETAILED DESCRIPTION OF THE INVENTION

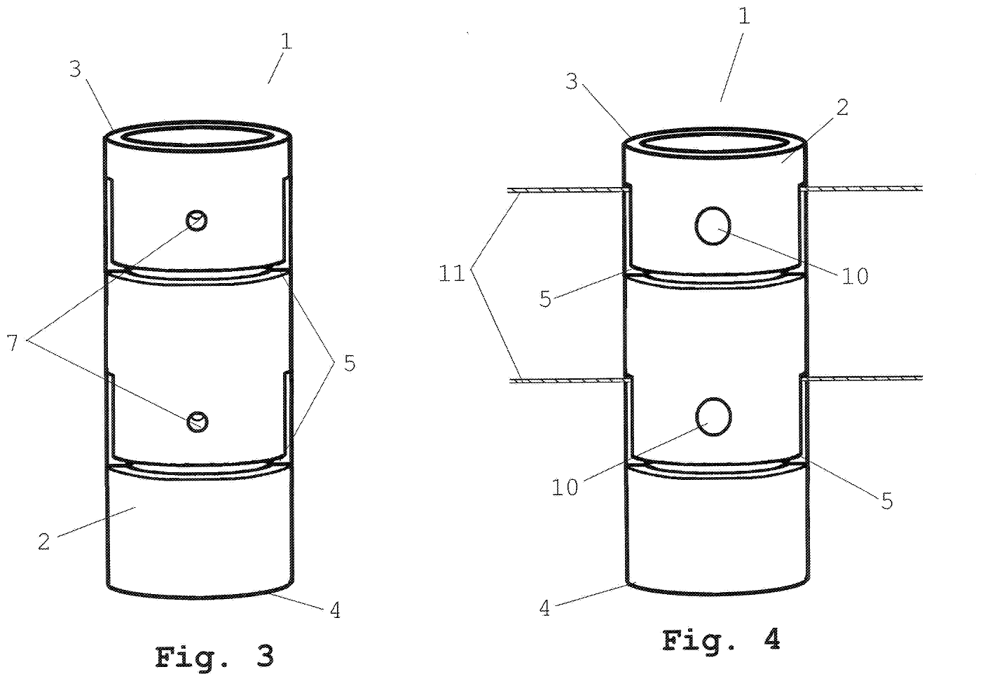

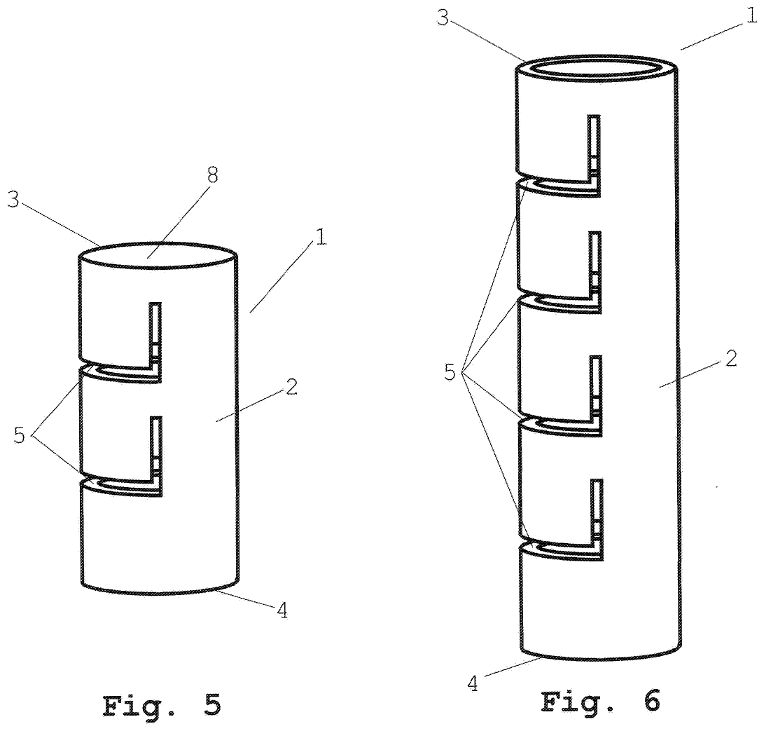

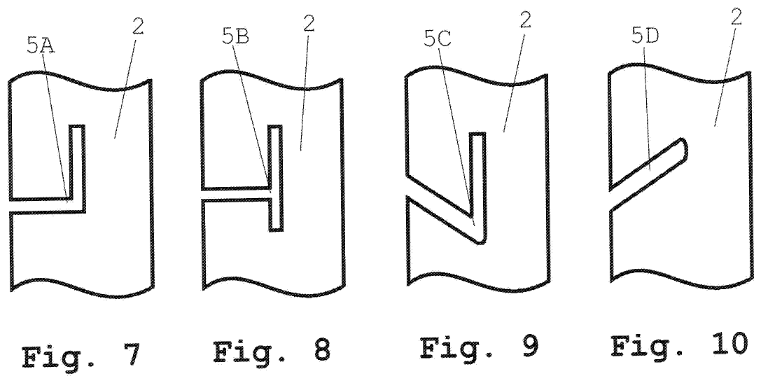

Referring to the drawings, FIGS. 1-3 depicts a first embodiment of a wire fence marker 1 which has a marker body 2 with an upper end 3 and a lower end 4 and one or more retaining slots 5.

The first embodiment of the drying device 1 has a marker body 2 which is preferably made of plastic, but may also be made of metal, wood, composite, cardboard, or other rigid or semi-rigid material. The marker body is generally elongated and has an upper end 3 and a lower end 4. The preferred embodiment of the marker body is cylindrical, but oval, square, or polygonal cross sections may also be used. Additionally, the upper and lower ends 3, 4 are preferably open, but either may feature a closed end 8. The marker body 2 is preferably hollow but may be solid.

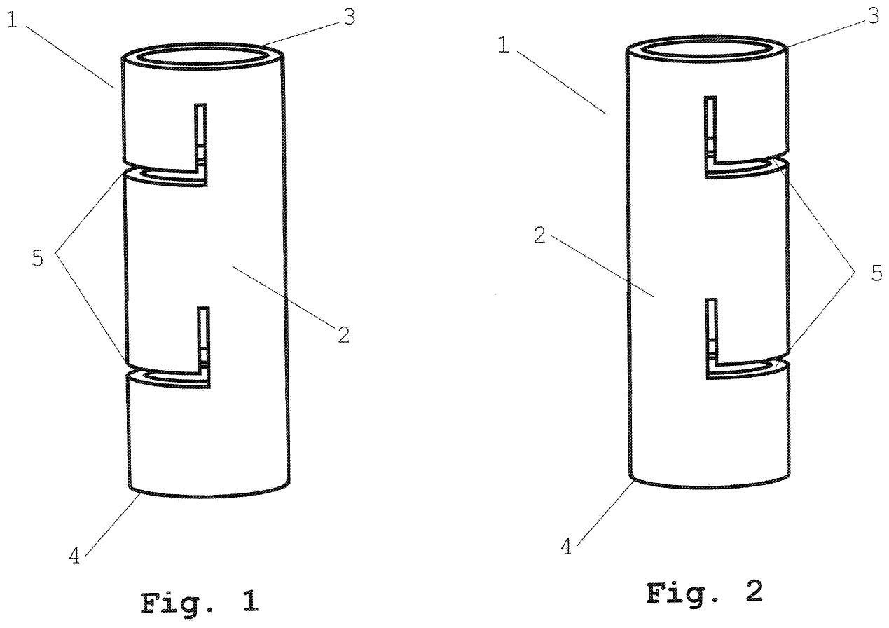

The marker body 2 also features a number of slots cut into the body. The slots may be retaining slots 5 or a longitudinal slot 6. In the preferred embodiment, the marker body 2 will have one or more retaining slots 5 which are in the general shape of an L. The L retaining slot 5A should be placed on the marker body 2 such that the vertical portion of the L is parallel to the longitudinal axis of the marker body 2 and positioned approximately at the center of the marker body 2 as depicted in FIGS. 1 and 2. Additionally, the marker body may feature an open section 9 which extends longitudinally along the entire length of the marker body and positioned on the side opposite the retaining slots 5.

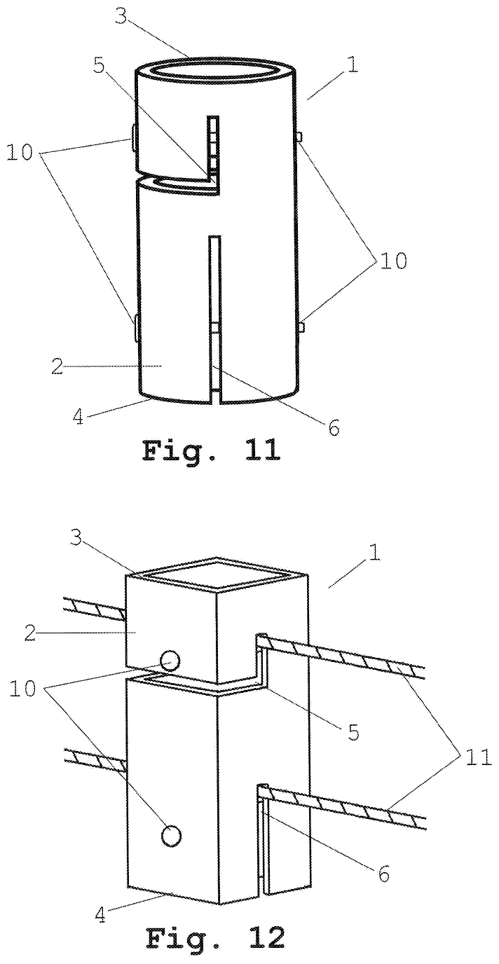

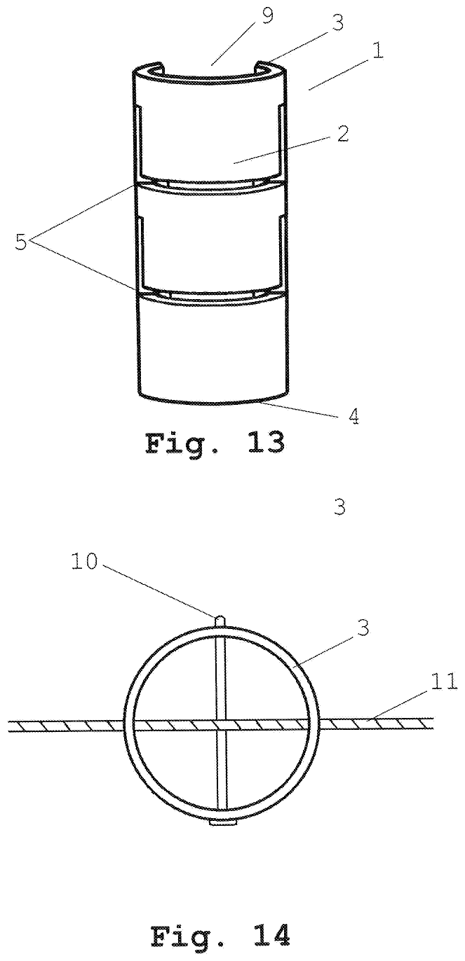

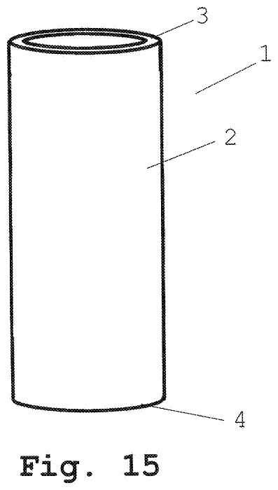

While the L slot 5A is the preferred embodiment of the retaining slot 5, other configurations may be used. While not an exhaustive list, the following are considered to be acceptable retaining slot configurations: T Slot 5B, V slot 5C, and angle slot 5D which are configured as shown in FIGS. 8-10.

In a second embodiment depicted in FIGS. 11 and 12, in addition to one or more retaining slots 5, the marker body 2 may have a longitudinal slot 6 which is located proximate the lower end 4 of the marker body 2. The longitudinal slot 6 is located approximately at the center of the marker body 2 and runs parallel to the longitudinal axis of the marker body 2 as depicted in FIGS. 11 and 12.

Referring to the FIGS. 4 and 12, the marker body may also feature fastener holes 7. The fastener holes should go completely through the marker body 2 and be positioned on the marker body 2 such that they are between the upper and lower extents of a retaining slot 5 or between the upper extent of a longitudinal slot 6 and the lower end 4 of the marker body 2. The wire fence marker may also use fasteners 10 which are inserted through the fastener holes and are configured to prevent the marker body from coming dislodged from a fence, wire, or cable on which it is installed. The preferred form of the fastener 10 is a push in rivet, but the fastener may also be a screw, nut and bolt, pin, zip tie, wire or other fastener known in the art.

To operate the first embodiment of the wire fence marker 1, a wire or cable strand 11 is placed into the uppermost retaining slot 5. Then, a second, lower wire 11 is placed into a second retaining slot 5. Subsequent fence wires 11 may be inserted into additional retaining slots if there are both additional wires 11 and additional retaining slots 5. All wires 11 should be placed in the retaining, slots 5 such that they are above the fastener holes 7. Finally, fasteners 10 should be inserted through the fastener holes 7 and secured. When the fasteners 10 are installed, each wire or cable strand 11 should be captive between the upper bound of the retaining slot 5 in which it is placed and a fastener. The arrangement of the fasteners 10 to the wire or cable 11 can be seen in FIGS. 12 and 14.

To operate the second embodiment of the wire fence marker 1, a wire or cable strand 11 is placed into the retaining slot 5. Then, a second, lower wire 11 is placed into the longitudinal slot 6. These steps may be reversed such that the lower wire is installed into the longitudinal slot 6 prior to a higher wire being installed into a retaining slot5. Finally, fasteners 10 should be inserted through the fastener holes 7 and secured. When the fasteners 10 are installed, each wire or cable strand 11 should be captive between the upper bound of the retaining slot 5 or longitudinal in which it is placed and a fastener.

While this invention has been described with the specific embodiments outlines above, the preferred embodiments set forth are intended to be illustrative, not limiting. Various changes may be made without departing from the scope of the invention as defined in the following claims. The claims provide the scope of coverage of this invention and should not be limited to the specific examples cited above.

What is claimed is:

1. A wire fence marker comprising a marker body and a retention slot.

2. A wire fence marker to comprising a marker body and a plurality of retention slots.

3. A wire fence marker to comprising a marker body, a retention slot and a longitudinal slot.

4. The wire fence marker described in claim 1 further comprising a fastener hole.

5. The wire fence marker described in claim 2 further comprising a plurality of fastener holes.

6. The wire fence marker described in claim 3 further comprising a plurality of fastener holes.

7. The wire fence marker described in claim 4 further comprising a fastener.

8. The wire fence marker described in claim 5 further comprising a plurality of fasteners.

9. The wire fence marker described in claim 6 further comprising a plurality of fasteners.
